(19) United States
(12) Patent Application Publication
(10) Pub. No.: US 2005/0252022 A1
(43) Pub. Date: Nov. 17, 2005

(54) Centrifugal lint trap

(76) Inventor: Warren Tyau, Honolulu, HI (US)

Correspondence Address: Wilson Daniel Swayze, JR., 3804 Clearwater Ct., Plano, TX, 75025, US

(21) Appl. No.: 11/131,170

(22) Filed: May 17, 2005

Related U.S. Application Data
(60) Provisional application No. 60/571,647, filed on May 17, 2004.

(51) Int. Cl. F26B 21/06; F26B 11/02

(52) U.S. Cl. 34/82; 34/606

(57) ABSTRACT

A lint trap for trapping air particles includes an air inlet for allowing the air particles to enter the lint trap and a base having a tapered gradient for increasing the velocity of the air particles and containment by centrifugal force. The air inlet is connected to a dryer.

### PRIORITY

The present application claims priority under 35 USC section 119 based upon application Ser. No. 60/571, 647 filed on May 17, 2004.

### FIELD OF THE INVENTION

The present invention relates to filters and more particularly to lint filters used with clothes dryers.

### BACKGROUND OF THE INVENTION

In clothes dryers of the type having a rotatable drum through which heated or unheated air is forced to flow to dry clothes, lint removal usually includes a filter positioned in or adjacent to the outlet for air from the clothes dryer. Additionally, many homes, apartments and condominiums do not have the ductwork to duct the outlet for the clothes dryers to the outside. The only alternative is to have the clothes dryer vent the output from the clothes dryer into the living area. The consequence of this type of ducting is that the living areas are saturated with the lint that is not trapped by the internal filter screen. The problem with these types of clothes dryers is that the internal filter screen does not remove all of the lint that is exhausted from the clothes dryer. The lint that escapes could be sufficiently small so that it passes through the internal filter screen or as lint builds up on the filter, pieces of trapped lint break off from the filter and are expelled to the ambient atmosphere. It is desirable to have a secondary filtering system that is different in type from the primary filter. In this way, the lint that escapes from the primary screen filter is contained.

### SUMMARY OF THE INVENTION

The present invention includes a conical chamber which improves the efficiency of lint collection by inducing a swirling action to the air stream, thereby creating a centrifugal force which greatly increases the efficiency of lint collection. As a result of this increased efficiency, the air quality in the living areas is greatly improved. The present invention requires no moving parts and does not require an external power source. The present invention is easy to clean and maintain and can be mounted on the wall for easy access. The lint trap of the present invention generates a gentle swooshing sound, which is a result of the swirling of water which may be audible as the exhaust air flows through the conical collection chamber. The lint trap of the present invention effectively utilizes water and moisture condensation as a surfactant to trap airborne particles ducted through the collection chamber. This centrifugal action compresses the air slightly and results in a moderate increase in velocity. The compression causes the airborne particles to coalesce through inertia impaction (liquid and particle) or Brownian diffusion (particle and particle). The resulting centrifugal force pushes the coalesced particles into the wetted walls of the chamber and the free surface of the water, completing the air scrubbing process and providing substantially lint free air to be exhausted from the filter. To further increase the filter's efficiency, a removable/washable, internal cylindrical filter screen acts to trap lint particles against the side of the conical collection chamber. The cylindrical filter screen is not a “flow through” or “pass through” filter. Unlike pass through filters which increase back pressure when a heavy layer of dirt/lint has accumulated, a cylindrical internal filter screen will not cause an increase in dryer exhaust back pressure as lint begins to deposit on the filter screen.

The lint filter of the present invention uses ordinary tap water or any other suitable liquid as a surficant. This provides an inexpensive filter medium. The lint filter of the present invention will not substantially reduce or restrict dryer exhaust airflow rate and will not degrade dryer efficiency.

### BRIEF DESCRIPTION OF THE DRAWINGS

FIG. 1 illustrates a cross-sectional view of the lint filter of the present invention;

FIG. 2 illustrates a perspective view of the lint filter of the present invention;

FIG. 3 illustrates three dimensional wire frame view of the lint filter of the present invention;

FIG. 4 illustrates a side view of the lint filter of the present invention.

### DETAILED DESCRIPTION

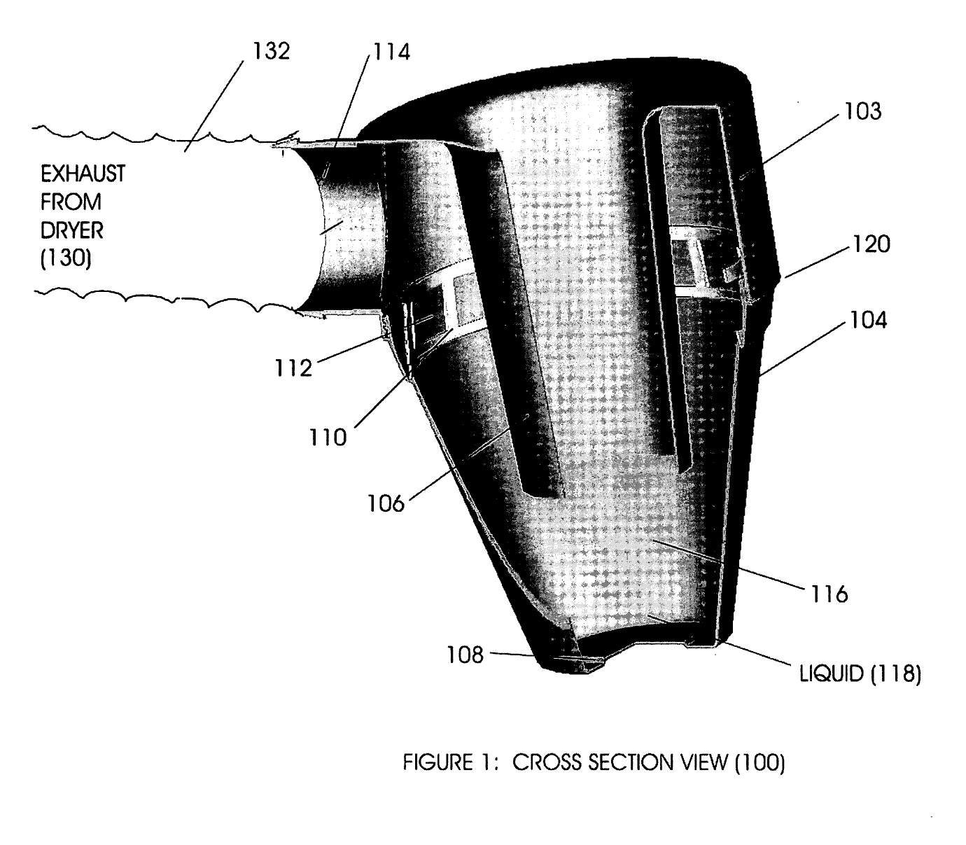

FIG. 1 illustrates the lint trap 100 which includes a collection chamber 116 and an air inlet fitting 114. The collection chamber 116 includes an outer hollow housing 102 which includes an upper housing 103 and a conical base 104, and tapered inner tube 106. A liquid 118 for example water or any other suitable liquid is placed in the bottom of the removable base 104. The upper housing 103 is substantially a cylinder and is formed with or attached to the air inlet fitting 114 for attachment to clothes dryer 130 through an appropriate tubing 132. The removable base 104 has a tapered gradient to compress the air and increase the velocity of the air as it travels down the tapered gradient. This compression of the air causes the airborne particles such as lint to coalesce through inertial impaction (liquid and particle) or Brownian diffusion (particle and particle). The resulting centrifugal force pushes the coalesced particles into the wetted walls and/or the cylindrical inner screen of the removable base 104 and the surface of the liquid 118 or water thereby completing the air scrubbing process. The removable base 104 has a bottom 108 which is shown as flat but could include other shapes to form a collection chamber together with the liquid 118 to hold the coalesced particles.

FIG. 1 additionally shows the inner tube 106 to exhaust the now clean air from the lint trap 100. The inner tube 106 extends from the top of the outer housing 102 into the removable base 104 but does not necessarily extend to the bottom 108 of the removable base 104. The inner tube 106 is positioned in a spaced relationship to the upper housing 103 and the removable base 104 to allow air to circulate and exhaust from the air inlet fitting 114 to the bottom 108 of the removable base 104. In this manner, the inner tube 106 does not substantially interfere with the cleaning of the airborne particles. The upper housing 103 is connected to the removable base 104 by a treaded connection 120 so that the upper housing 103 and the removable base 104 remains connected until the removable base 104 is detached from the upper housing 103.

FIG. 1 additionally shows a filter screen frame 110 to support a filter screen 112 which may be a fine mesh. The filter screen 112 filters the airborne particles to the extent that such filtering can be achieved. However, very small airborne particles may go through the filter screen, or debris from the filter screen 112 may fall off the filter screen 112. The collection chamber includes the removable base 104 having a tapering gradient, the bottom 108 of the removable base 104 and the liquid 118 collected in the bottom of the collection chamber. This collection chamber will trap the airborne particles that pass through the filter screen 112. The liquid 118 and moisture compensation that results from the liquid 118 act as a surfactant to trap the airborne particles in the liquid 118 and on the walls of the removable base 104. The principles of the present invention also apply to a lint trap that is vented to the outside or to some other area. FIG. 1 shows that the inner tube 106 exhausts the now clean air to the room. Consequently, the air quality of the interior room is improved.

The clothes dryer 130 exhausts air containing particles through tubing 132 to the air inlet fitting 114 which allows the air containing particles to enter the lint trap 100. The air and particles flow into the centrifugal chamber 116 and flow through the filter screen 112, removing a portion of the particles. However, a portion of the particles may not the filtered by the filter screen 112. The air containing reduced particles move along the tapered gradient of the removable base 104, increasing in speed. The particles are collected by the liquid 118 or water found at the bottom 108 of the removable base 104 or the walls of the removable base 104. The now clean air moves up the inner tube 106 and into the atmosphere or room. When sufficient lint has been captured by removable base 104, the removable base 104 is removed by unscrewing the base at the treaded connection 120. Their removable base 104 is cleaned, repositioned and held by connection 120.

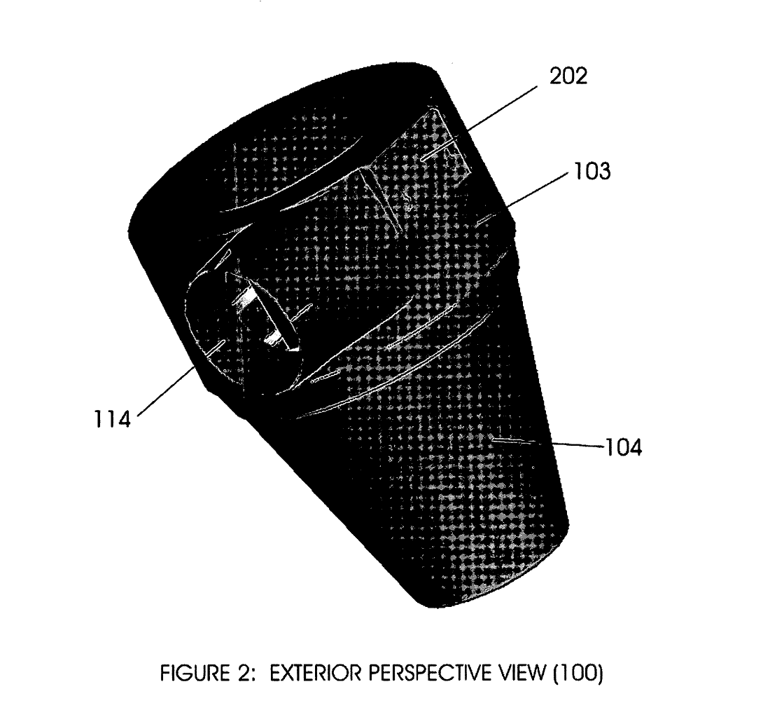

FIG. 2 illustrates a perspective view of the outside of the lint trap 100. FIG. 2 shows a mounting plate 202 which may be formed with the upper housing 103 or attached to the upper housing 103. The mounting plate 202 can be used for mounting the lint trap 100 on the wall.

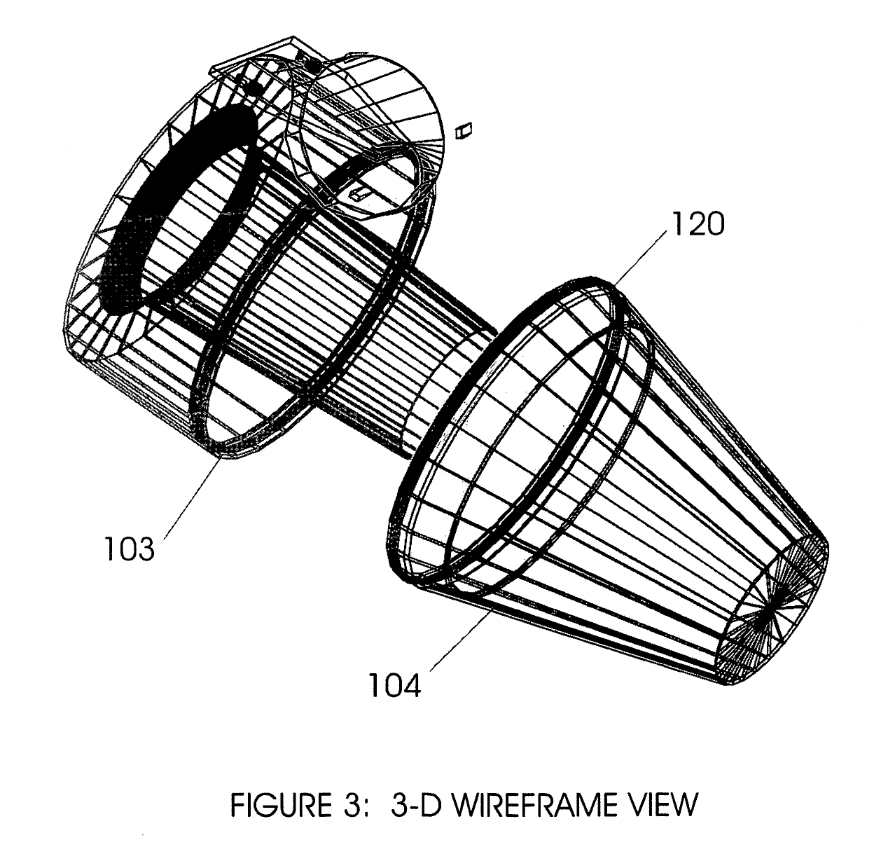

FIG. 3 illustrates a three dimensional wire frame view of the lint trap 100. The removable base 104 is shown separated from the upper housing 103 at the threaded (screw-on) connection 120.

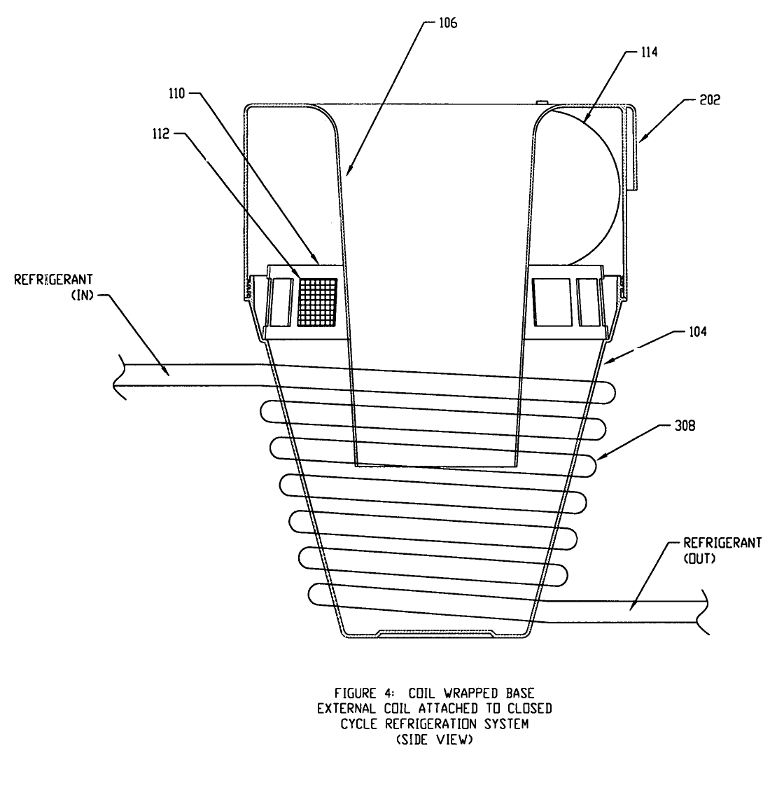

Furthermore, increasing the overall size of the lint trap in proportion should increase particle retention efficiency. More particularly, increasing the height with respect to the width will increase the dwell time for example the number of turns which the air makes through the centrifugal chamber. While fabricating the lint trap from aluminum will increase the internal condensation efficiency, resulting in cooler collection chamber temperatures. FIG. 4 additionally illustrates a coil 308 wrapped around the outside of the removable base 104 which could be filled with refrigerant to lower the temperature of the removable base 104. A refrigerated embodiment of the invention could be adapted for “ductless” dryers which use a closed cycle refrigeration system to condense the moisture in the clothes dryer, instead of evaporating the moisture by using heat.

Thus, although the invention has been illustrated and disclosed with reference to the preferred embodiment, it is understood that substitutions may be made and equivalents employed herein, without departing from the scope of the invention as set forth in the claims.

1) A lint trap for trapping air particles, comprising:
an air inlet for allowing said air particles to enter said lint trap;
a base having a tapered gradient for increasing the velocity of said air particles;
said air inlet being connected to a dryer.

2) A lint trap for trapping air particles as in claim 1 wherein said base is removable.

3) A lint trap for trapping air particles as in claim 1 wherein said lint trap includes an internal filter screen to filter said air particles, without significantly increasing back pressure.

4) A lint trap for trapping air particles as in claim 1 wherein said lint trap includes an inner tube to exhaust: said air particles after filtering.

5) A lint trap for trapping air particles as in claim 1 wherein said base includes a nonstick coating.

6) A lint trap for trapping air particles as in claim 1 wherein said lint trap includes a pump to add water to said lint trap.

7) A lint trap for trapping air particles as in claim 1 wherein said base is formed from aluminum.

8) A lint trap for trapping air particles as in claim 1 wherein said base is chilled by a coil.

9) A method for forming a lint trap for trapping air particles, comprising:
forming an air inlet for allowing said air particles to enter said lint trap;
forming a base having a tapered gradient for increasing the velocity of said air particles;
said air inlet being connectable to a dryer.

10) A method for forming a lint trap for trapping air particles as in claim 9 wherein said base is formed to be removable.

11) A method for forming a lint trap for trapping air particles as in claim 9 wherein said method includes forming a filter screen to filter said air particles.

12) A method for forming a lint trap for trapping air particles as in claim 9 wherein said method includes forming an inner tube to exhaust said air particles after filtering.

13) A method for forming a lint trap for trapping air particles as in claim 11 wherein said method includes forming a vane positioned between said inner tube and said base to increase condensation.

14) A method for forming a lint trap for trapping air particles as in claim 9 wherein said method includes forming a nonstick coating on said base.

15) A method for forming a lint trap for trapping air particles as in claim 9 wherein said method includes forming a pump to add water to said lint trap.

16) A method for forming a lint trap for trapping air particles as in claim 9 wherein said base is formed from aluminum.

17) A method for forming a lint trap for trapping air particles as in claim 9 wherein said base is chilled by a closed cycle refrigeration coil.
